(19) United States
(12) Patent Application Publication
(10) Pub. No.: US 2014/0063341 A1
(43) Pub. Date: Mar. 6, 2014

(54) METHOD AND APPARATUS FOR SCALABLE BROADCAST

(71) Applicant: ELECTRONICS AND TELECOMMUNICATIONS RESEARCH INSTITUTE, Daejeon-si (KR)

(72) Inventors: Byung Jun BAE, Daejeon (KR); Joon Young JUNG, Daejeon-si (KR); Hyoung Soo LIM, Daejeon-si (KR); Yong Tae LEE, Daejeon-si (KR); Yun Jeong SONG, Daejeon-si (KR); Nam Ho HUR, Daejeon-si (KR); Eung Don LEE, Daejeon-si (KR)

(73) Assignee: ELECTRONICS AND TELECOMMUNICATIONS RESEARCH INSTITUTE, Daejeon-si (KR)

(21) Appl. No.: 13/972,190

(22) Filed: Aug. 21, 2013

(30) Foreign Application Priority Data
Aug. 29, 2012 (KR) 10-2012-0094925

(51) Int. Cl. H04N 7/01

(52) U.S. Cl. CPC H04N 7/0125
USPC 348/441

(57) ABSTRACT

Disclosed are a method and an apparatus for a scalable broadcast. The method includes scalably dividing a broadcast frequency band into segments, scalably dividing a video image into segments, and linking the segment of the broadcast frequency band to the scalably divided video image, and broadcasting the linked segments to at least one receiving apparatus.

This application claims the benefit of priority of Korean Patent Application No. 10-2012-0094925 filed on Aug. 29, 2012, which is incorporated by reference in its entirety herein.

### BACKGROUND OF THE INVENTION

1. Field of the Invention

The present invention relates to a scalable broadcast, and more particularly, to a scalable broadcast that provides a broadcast of various qualities of definition in accordance with user's reception conditions for broadcasting signals.

2. Discussion of the Related Art

Terrestrial Digital Multimedia Broadcasting (DMB) is a mobile broadcast system standard in which a video service is added to a Digital Audio Broadcasting (DAB) system which is an audio broadcast developed in Europe in 1990. At an initial stage of a terrestrial DMB service, the service can be provided with Quarter Video Graphic Array (QVGA) class video definition in which the resolution of mobile terminals is 320*240. In recent years, with the appearance of smart phones and tablet computers, a high resolution display has been applied to even DMB receiving terminals, and as a result, a definition problem associated with the terrestrial DMB service comes to the fore. Since the terrestrial DMB system is based on quite an old standard, it is difficult to apply a service having Standard Definition (SD) class video definition, further High Definition (HD) class video definition. In reality the level of the users' eye is getting higher, it is necessary to provide a video service of the SD class or HD class even in a mobile broadcast.

Recently, in Japan, a mobile broadcast system and a mobile broadcast service called IDSB-Tmm based on Integrated Service Digital Broadcasting (ISDB)-One seg mobile broadcasting, similar to Korean DMB have been developed, through which the SD class video definition service can be provided. However, this service has also been developed by considering compatibility with the existing ISDB-One seg service, and as a result, the IDSB-Tmm service has a system structure in which it is impossible to provide more developed various services. That is the SD class definition or the QVGA class definition can be sent to specific users, but it is difficult to use a service of various qualities of definition depending on a broadcast reception environment of the user.

A new type of mobile broadcast system needs to be developed, which can provide the service of various qualities of definition depending on the broadcast reception environment of the user.

### SUMMARY OF THE INVENTION

An objet of the present invention is to provide a broadcast service of various qualities of definition by considering a broadcast service reception environment of a user.

Another object of the present invention is to provide a method and an apparatus for a flexible scalable broadcast depending on a characteristic of a receiving apparatus.

In accordance with an embodiment of the present invention, a method for a scalable broadcast, includes: dividing a broadcast frequency band into at least one segment; scalably dividing a video image into at least one segment; and linking the segment of the broadcast frequency band to the segment of the scalably divided video image and broadcasting the linked segments to at least one receiving apparatus, in which one segment is divided as one unit when the video image is a Quarter Video Graphic Array (QVGA) definition image, two segments are divided as one unit when the video image is a Standard Definition (SD) definition image, and three (alternatively, four) segments are divided as one unit when the video image is a High Definition (HD) definition image, and an image of a base layer of Scalable Video Coding (SVC) is allocated to a first segment of the broadcast frequency band, data of an intermediate layer of the SVC is allocated to a second segment of the broadcast frequency band, and data of an upper layer of the SVC is allocated to a third segment (alternatively, third and fourth segments) of the broadcast frequency band.

In accordance with another embodiment of the present invention, an apparatus for a scalable broadcast, includes: a controller configured to divide a broadcast frequency band into at least one segment, scalably divide a video image into at least one segment, and link the segment of the broadcast frequency band to the scalably divided video image; and a transmitter configured to broadcast the segment of the broadcast frequency band linked with the video image to at least one receiving apparatus, and the controller divides one segment as one unit when the video image is a Quarter Video Graphic Array (QVGA) definition image, divides two segments as one unit when the video image is a Standard Definition (SD) definition image, and divides three (alternatively, four) segments as one unit when the video image is a High Definition (HD) definition image, and allocates an image of a base layer of Scalable Video Coding (SVC) to a first segment of the broadcast frequency band, allocates data of an intermediate layer of the SVC to a second segment of the broadcast frequency band, and allocates data of an upper layer of the SVC to a third segment (third and fourth segments) of the broadcast frequency band.

In accordance with embodiments of the present invention, a service of various qualities of definition can be used depending on a reception environment of a user, by dividing a frequency into segments, performing scalable source coding, and applying different channel coding degrees to the service.

Further, an optimal service can be provided in various network environments and various terminals, when intelligent broadcast contents are provided in a broadcast and communication integration environment.

### BRIEF DESCRIPTION OF THE DRAWINGS

FIG. 1 illustrates one example in which a broadcasting apparatus performs a scalable broadcast according to an embodiment of the present invention.

FIG. 2 is a flowchart illustrating a method in which a broadcasting apparatus performs a scalable broadcast according to an embodiment of the present invention.

FIG. 3 is a block diagram illustrating one example of a broadcasting apparatus that performs a scalable broadcast according to an embodiment of the present invention.

### DETAILED DESCRIPTION OF THE EMBODIMENTS

Hereinafter, embodiments of the present invention will be described in detail with reference to the accompanying drawings such that those skilled in the art can easily implement the embodiments. However, the present invention may be implemented in various different forms and hereinafter, the present invention is not limited to exemplary embodiments described below. Further, elements which are not associated with the present invention are omitted in order to clearly describe the present invention and in the drawings, like reference numerals refer to like or similar elements.

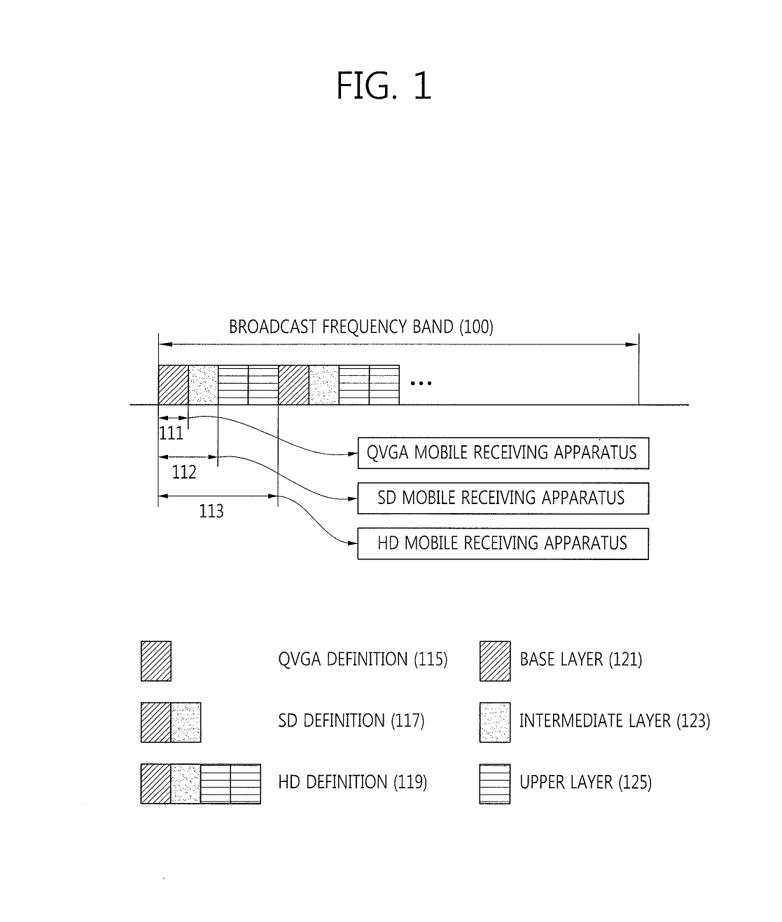

FIG. 1 illustrates one example in which a broadcasting apparatus performs a scalable broadcast according to an embodiment of the present invention. The broadcasting apparatus may be one of apparatuses which may perform all kinds of broadcasts, such as a smart phone, or the like, through which individuals may perform a broadcast as well as a base station and a broadcasting station.

Referring to FIG. 1, the broadcasting apparatus may transmit a broadcast frequency band 100 which is divided (alternatively, partitioned) into predetermined unit segments. The broadcast frequency band 100 may be a wideband frequency band and may be equal to or larger than 6 MHz. The size and the unit of one segment may be determined depending on the broadcast frequency band 100.

As an embodiment of the present invention, a basic unit of a transmitted segment may be variably applied in accordance with a content of a transmitted service (e.g., a content of a primary transmitted service). For example, one segment may be transmitted as one unit (111). For another example, two segments may be transmitted as one unit (112). As yet another example, three or four segments may be transmitted as one unit (113). As another example, n (n is an integer) segments may be transmitted as one unit (not illustrated).

In the case where one segment is transmitted as one unit, a fifth (alternatively, a fourth) segment may be transmitted as one unit again by considering a case in which two or four (alternatively, three) segments are transmitted to another user (alternatively, a receiving apparatus) as one unit. Similarly, in the case where two segments are transmitted as one unit, four (alternatively, three) segments are transmitted to another user (alternatively, the receiving apparatus) as one unit, and as a result, fifth and sixth segments (alternatively, the fourth and fifth segments) may be transmitted as one unit.

As another embodiment of the present invention, one mobile broadcast service may be provided by dividing the transmission frequency band into the segments (e.g., one segment as one unit (111), two segments as one unit (112), or four segments as one unit (113)) as described in the embodiment, scalably dividing a video image into segments stepwise (for example, one, two, or four segments as one unit), and linking the divided video image and transmission frequency band.

For example, one segment is divided as one unit (111), and one segment of the transmission frequency band and one segment of the video image are linked to each other to transmit a QVGA definition content 115 to a QVGA mobile receiving apparatus. As one example, the QVGA definition represents 320*240 resolution.

For example, two segments are divided as one unit (112), and two segments of the transmission frequency band and two segments of the video image are linked to each other to transmit an SD definition content 117 to an SD mobile receiving apparatus. SD definition represents 1280*720 resolution.

For example, four segments are divided as one unit (113), and four segments of the transmission frequency band and four segments of the video image are linked to each other to transmit an HD definition content 119 to an HD mobile receiving apparatus. D definition represents 1920*1080 resolution or more. Alternatively, three segments are divided as one unit, and three segments of the transmission frequency band and three segments of the video image are linked to each other to transmit the HD definition content to the HD mobile receiving apparatus.

In detail, an image of a base layer 121 of scalable video coding (SVC) may be allocated to a first segment, data of an intermediate layer 123 may be allocated to a second segment, and data of an upper layer 125 may be allocated to third and fourth segments. The SVC is one example of video coding, and in the SVC, an algorithm such as LDPC or Turbo may be used.

A service of various qualities of definition may be provided depending on the reception environment of the user by applying the SVC to the transmitted video image, and herein, the SVC represents video coding using a base layer and one or more scalable enhancement layers. In the SVC, the base layer generally transmits video data having a base quality level, and at least one enhancement layer transmits additional video data so as to support an upper space level, a time level, and/or a signal to noise ratio (SNR) level.

According to the embodiment, a user who receives the first segment may use a QVGA class video definition service 115, a user who receives the first and second segments may use an SD class video definition service 117, and a user who receives all of the first, second, third, and fourth segments may use the HD class video definition service 119.

That is, the broadcasting apparatus may perform the broadcast at the same time to the QVGA mobile receiving apparatus, the SD mobile receiving apparatus, and the HD mobile receiving apparatus. Further, since the broadcast frequency band is scalably divided into the segments to be transmitted, the broadcast frequency band need not be constantly determined as 6 MHz and may have a value larger than 6 MHz or may be variably determined.

As yet another embodiment of the present invention, in order to more efficiently provide the scalable mobile broadcast service, the transmission channel coding degree may be applied differently depending on a scalable service (alternatively, an aspect of scalably transmitting the segment). For example, a strong channel coding degree may be applied to the data of the first segment which is the most important data providing base definition, an intermediate channel coding degree may be applied to the data of the second segment, and a weak channel coding degree may be applied to the data of the third and fourth segments (alternatively, the data of the third segment). The strength and weakness of the channel coding degree may be relative and may be absolute as defined in a predetermined standard.

Since a transmittable data amount is smaller as the channel coding degree is stronger, it is efficient to apply the channel coding degree to be weaker as the definition is higher.

According to the present invention, the user may use the HD class mobile broadcast service through one broadcasting apparatus in a region where the broadcast reception environment is excellent, the SD class mobile broadcast service in a region where the broadcast reception environment is intermediate, and the QVGA class mobile broadcast service in a region where the broadcast reception environment is bad.

Meanwhile, since a target service and the amount of transmitted data are different for each segment, the channel coding algorithm may also be applied differently depending on a characteristic thereof. That is, the data channel coding algorithm may be adopted differently for each segment. For example, the algorithm such as the LDPC or Turbo may be used.

FIG. 1 described above illustrates only one embodiment of the present invention, and the number of segments used for each service, the unit of transmitted segments, a data amount in the segment, or a channel coding degree or an applied algorithm may be variable.

In accordance with embodiments of the present invention, a service of various qualities of definition may be used depending on a reception environment of a user by dividing a frequency into segments, performing scalable source coding, and applying different channel coding degrees to the service. Further, an optimal service may be provided in various network environments and various terminals when intelligent broadcast contents are provided in a broadcast and communication integration environment.

Accordingly, in Korea at present, the broadcast frequency is allocated and used by the unit of 6 MHz, but a band of 6 MHz or more may be allocated for a new service, in the new mobile broadcast system and apparatus and the scalable mobile broadcast system and apparatus of the present invention. That is, a system structure is provided, which needs not be subordinate to the existing base unit of 6 MHz.

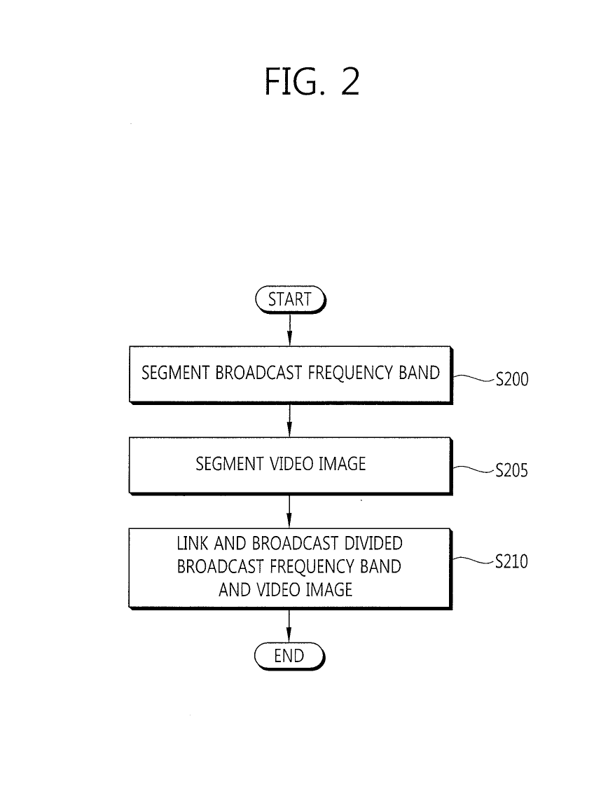

FIG. 2 is a flowchart illustrating a method in which a broadcasting apparatus performs a scalable broadcast according to an embodiment of the present invention. All steps described below need not be performed, and the present invention may be performed by only at least one of the steps described below.

Referring to FIG. 2, the broadcasting apparatus divides a transmission frequency band into at least one segment (S200). For example, the broadcasting apparatus may divide one segment as one unit 111, divide two segments as one unit 112, or divide four segments as one unit 113. Alternatively, the broadcasting apparatus may divide three segments as one unit.

The broadcasting apparatus scalably divides a video image received from a broadcasting server stepwise (S205). In a QVGA definition image, one segment may be divided as one unit, in an SD definition image, two segments may be divided as one unit, or in an HD definition image, four segments may be divided as one unit. Further, in the HD definition image, three segments may be divided as one unit.

The broadcasting apparatus provides links the divided transmission frequency band and the divided video image to each other to provide one mobile broadcast service (S210). In this case, SVC video coding may be used, and an image of a base layer 121 of SVC may be allocated to a first segment, data of an intermediate layer 123 may be allocated to a second segment, and data of an upper layer 125 may be allocated to third and fourth segments. Further, the data of the upper layer may be allocated to the third segment. That is, one segment is divided as one unit 111 and a QVGA definition content 115 is linked to transmit the content 115 to a QVGA mobile receiving apparatus. Further, two segments are divided as one unit (112) and an SD definition content 117 is linked to transmit the content 117 to an SD mobile receiving apparatus. In addition, four segments are divided as one unit (113) and an HD definition content 119 is linked to transmit the content 119 to an HD mobile receiving apparatus. Further, three segments are divided as one unit and the HD definition content is linked to transmit the content to the HD mobile receiving apparatus.

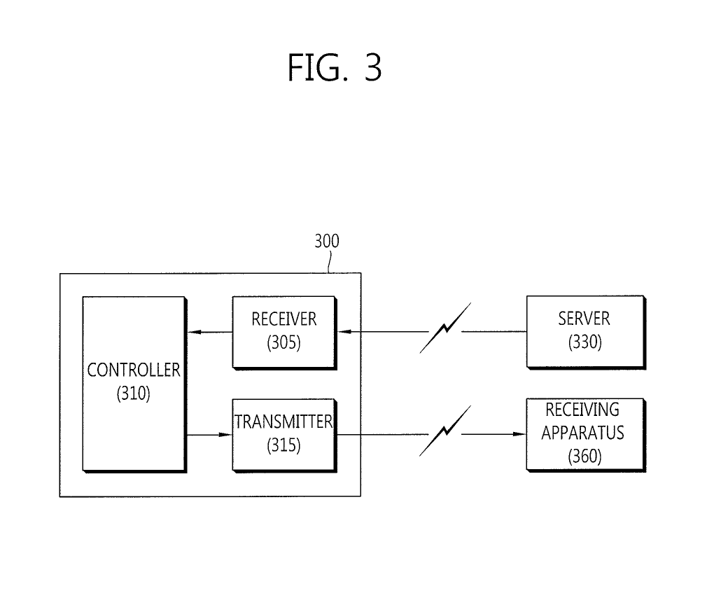

FIG. 3 is a block diagram illustrating one example of a broadcasting apparatus that performs a scalable broadcast according to an embodiment of the present invention.

Referring to FIG. 3, a broadcasting apparatus 300 may include at least one of a receiver 305, a controller 310, and a transmitter 315.

The receiver 305 receives a video image from a broadcasting server 330. In this case, the broadcasting apparatus 300 and the broadcasting server 330 may be connected wirelessly or in a wired method.

The controller 310 may divide a transmission frequency band into segments. For example, one segment may be divided as one unit 111, two segments may be divided as one unit 112, or four segments may be divided as one unit 113. Further, three segments may be divided as one unit.

The controller 310 may scalably divide a video image received from the broadcasting server 330 stepwise. In a QVGA definition image, one segment may be divided as one unit, in an SD definition image, two segments may be divided as one unit, or in an HD definition image, four segments may be divided as one unit. Further, in the HD definition image, three segments may be divided as one unit.

The controller 310 may link the divided transmission frequency band the divided video image in order to provide a mobile broadcast service. In this case, SVC video coding may be used, and an image of a base layer 121 of SVC may be allocated to a first segment, data of an intermediate layer 123 may be allocated to a second segment, and data of an upper layer 125 may be allocated to third and fourth segments. Further, the data of the upper layer may be allocated to the third segment.

The transmitter 315 performs a broadcast to a receiving apparatus 360 through a mobile broadcast network, or the like. The receiving apparatus 360 may be at least one of a QVGA mobile receiving apparatus that may handle the QVGA definition content, an SD mobile receiving apparatus that may handle the SD definition content, and an HD mobile receiving apparatus that may handle the HD definition content.

The transmitter 315 links the segment in which one segment is divided as one unit to the QVGA definition content to transmit the content to the QVGA mobile receiving apparatus. Further, the transmitter 315 links the segments in which two segments are divided as one unit to the SD definition content to transmit the content to the SD mobile receiving apparatus. Further, the transmitter 315 links the segments in which four segments are divided as one unit to the HD definition content to transmit the content to the HD mobile receiving apparatus. Alternatively, the transmitter 315 links the segments in which three segments are divided as one unit to the HD definition content to transmit the content to the HD mobile receiving apparatus.

In the aforementioned embodiments, although the methods have been described based on the flowcharts in the form of a series of steps or blocks, the present invention is not limited to the sequence of the steps, and some of the steps may be performed in a different order from other steps described above or at the same time. Furthermore, those skilled in the art will understand that the steps shown in the flowchart are not exclusive and the steps may include additional steps or that one or more steps in the flowchart may be deleted without affecting the scope of the present invention.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

What is claimed is:

1. A method for a scalable broadcast, comprising:
dividing a broadcast frequency band into at least one segment;
scalably dividing a video image into at least one segment; and
linking the segment of the broadcast frequency band to the segment of the scalably divided video image and broadcasting the linked segments to at least one receiving apparatus,
wherein one segment is divided as one unit when the video image is a Quarter Video Graphic Array (QVGA) definition image, two segments are divided as one unit when the video image is a Standard Definition (SD) definition image, and four segments are divided as one unit when the video image is a High Definition (HD) definition image, and
an image of a base layer of Scalable Video Coding (SVC) is allocated to a first segment of the broadcast frequency band, data of an intermediate layer of the SVC is allocated to a second segment of the broadcast frequency band, and data of an upper layer of the SVC is allocated to third and fourth segments of the broadcast frequency band.

2. The method of claim 1, wherein:
in the broadcast frequency band, one segment is divided as one unit, two segments are divided as one unit, or four segments are divided as one unit.

3. The method of claim 1, wherein:
a predetermined integer number of segments are divided as one unit in the broadcast frequency band.

4. The method of claim 1, further comprising:
receiving the video image from a broadcasting server wirelessly or in a wired method.

5. The method of claim 1, wherein:
the at least one receiving apparatus is one of a QVGA mobile receiving apparatus capable of receiving or reproducing a QVGA definition content, an SD mobile receiving apparatus capable of receiving or reproducing an SD definition content, and an HD mobile receiving apparatus capable of receiving or reproducing an HD definition content.

6. The method of claim 1, wherein:
the SVC is scalable video coding in which a transmission channel coding degree depends on a characteristic of the at least one receiving apparatus.

7. The method of claim 6, wherein:
a strong channel coding degree is applied to the first segment of the broadcast frequency band, an intermediate channel coding degree is applied to the second segment of the broadcast frequency band, and a weak channel coding degree is applied to the third and fourth segments of the broadcast frequency band.

8. An apparatus for a scalable broadcast, comprising:
a controller configured to divide a broadcast frequency band into at least one segment, scalably divide a video image into at least one segment, and link the segment of the broadcast frequency band to the scalably divided video image; and
a transmitter configured to broadcast the segment of the broadcast frequency band linked with the video image to at least one receiving apparatus,
wherein the controller,
divides one segment as one unit when the video image is a Quarter Video Graphic Array (QVGA) definition image, divides two segments as one unit when the video image is a Standard Definition (SD) definition image, and divides four segments as one unit when the video image is a High Definition (HD) definition image, and
allocates an image of a base layer of Scalable Video Coding (SVC) to a first segment of the broadcast frequency band, allocates data of an intermediate layer of the SVC to a second segment of the broadcast frequency band, and allocates data of an upper layer of the SVC to third and fourth segments of the broadcast frequency band.

9. The apparatus of claim 8, wherein:
the controller divides the broadcast frequency band into one segment as one unit, two segments as one unit, or four segments as one unit.

10. The apparatus of claim 8, wherein:
the controller divides the broadcast frequency band into a predetermined integer number of segments as one unit.

11. The apparatus of claim 8, further comprising:
a receiver configured to receive the video image from a broadcasting server wirelessly or in a wired method.

12. The apparatus of claim 8, wherein:
the at least one receiving apparatus is one of a QVGA mobile receiving apparatus capable of receiving or reproducing a QVGA definition content, an SD mobile receiving apparatus capable of receiving or reproducing an SD definition content, and an HD mobile receiving apparatus capable of receiving or reproducing an HD definition content.

13. The apparatus of claim 8, wherein:
the SVC is scalable video coding in which a transmission channel coding degree depends on a characteristic of the at least one receiving apparatus.

14. The apparatus of claim 13, wherein:
a strong channel coding degree is applied to the first segment of the broadcast frequency band, an intermediate channel coding degree is applied to the second segment of the broadcast frequency band, and a weak channel coding degree is applied to third and the fourth segments of the broadcast frequency band.
